(19) United States
(12) Patent Application Publication
(10) Pub. No.: US 2025/0286090 A1
(43) Pub. Date: Sep. 11, 2025

(54) ELECTROCHEMICAL CELL SYSTEMS INCLUDING FLUID EJECTOR

(71) Applicant: BLOOM ENERGY CORPORATION, San Jose, CA (US)

(72) Inventors: Jayakumar KRISHNADASS, Santa Clara, CA (US); David WEINGAERTNER, Sunnyvale, CA (US); Easwaramoorthy Vellakinar KANDASWAMY, Fremont, CA (US)

(21) Appl. No.: 19/051,752

(22) Filed: Feb. 12, 2025

Related U.S. Application Data
(60) Provisional application No. 63/563,708, filed on Mar. 11, 2024.

(51) Int. Cl. H01M 8/04082; C25B 9/77; C25B 15/08; H01M 8/04089; H01M 8/04111; H01M 8/04119; H01M 8/12; H01M 8/2457; H01M 8/2484; H01M 8/249

(52) U.S. Cl. CPC H01M 8/04201; C25B 9/77; C25B 15/08; H01M 8/04097; H01M 8/04111; H01M 8/04164; H01M 8/2457; H01M 8/2484; H01M 8/249; H01M 2008/1293

(57) ABSTRACT

An electrochemical cell system includes a stack of electrochemical cells, and a fluid ejector configured to mix a first fluid stream and a second fluid stream to form a mixed fluid stream that is provided to the stack. The fluid ejector includes a suction chamber having a secondary inlet configured to receive the second fluid stream, an inlet nozzle configured to inject the first fluid stream into the suction chamber, a mixing chamber fluidly connected to the suction chamber and configured to mix the first fluid stream and the second fluid stream to form the mixed fluid stream, and a diffusion chamber fluidly connected to the mixing chamber and having an outlet that is fluidly connected to the stack.

### FIELD

Aspects of the present invention relate to electrochemical cell systems, and more particularly, to solid oxide fuel cell and electrolyzer cell systems that include fluid ejectors.

### BACKGROUND

Fuel cells, such as solid oxide fuel cells, are electrochemical devices which can convert energy stored in fuels to electrical energy with high efficiency. High temperature fuel cells include solid oxide and molten carbonate fuel cells. These fuel cells may operate using hydrogen and/or hydrogen-containing fuels. There are classes of fuel cells, such as the solid oxide regenerative fuel cells, that also allow reversed operation, such that oxidized fuel can be reduced back to unoxidized fuel using electrical energy as an input.

### SUMMARY

According to various embodiments, an electrochemical cell system includes a stack of electrochemical cells; a first fluid ejector configured to mix a first fluid stream and a second fluid stream to form a mixed fluid stream that is provided to the stack, the first fluid ejector comprising: a suction chamber comprising a secondary inlet configured to receive the second fluid stream; an inlet nozzle configured to inject the first fluid stream into the suction chamber; a mixing chamber fluidly connected to the suction chamber and configured to mix the first fluid stream and the second fluid stream to form the mixed fluid stream; and a diffusion chamber fluidly connected to the mixing chamber and comprising an outlet that is fluidly connected to the stack.

According to various embodiments, a method of operating an electrochemical cell system comprises providing a first fluid stream to an inlet nozzle of a fluid ejector; providing a second fluid stream from a stack of electrochemical cells to a second inlet located in a suction chamber of the fluid ejector; mixing the first fluid stream and the second fluid stream in a mixing chamber of the fluid ejector to form a mixed fluid stream; and providing the mixed fluid stream from a diffusion chamber of the fluid ejector to the stack.

### BRIEF DESCRIPTION OF THE DRAWINGS

The accompanying drawings, which are incorporated herein and constitute part of this specification, illustrate example embodiments of the invention, and together with the general description given above and the detailed description given below, serve to explain the features of the invention.

FIG. 1A is a perspective view of a stack of electrochemical cells, according to various embodiments of the present disclosure, and FIG. 1B is a sectional view of a portion of the stack of FIG. 1A.

FIG. 2 is a schematic view of a fuel cell fuel cell system, according to various embodiments of the present disclosure.

FIG. 3 is a schematic diagram showing a process flow in an electrolyzer system 300, according to various embodiments of the present disclosure.

FIG. 4 is a schematic diagram of a fluid ejector that may be utilized in the systems of FIGS. 2 and 3, according to various embodiments of the present disclosure.

FIG. 5A is a schematic diagram showing a process flow in a SOFC system, according to various embodiments of the present disclosure.

FIGS. 5B-5D are schematic diagrams showing process flows of alternative SOFC systems, according to various embodiments of the present disclosure.

FIG. 6A is a schematic diagram showing a process flow in a SOEC system, according to various embodiments of the present disclosure.

FIGS. 6B and 6C are schematic diagrams showing process flows of alternative SOEC systems, according to various embodiments of the present disclosure.

FIG. 7A is a schematic diagram showing a process flow in a SOEC system, according to various embodiments of the present disclosure.

FIGS. 7B-7D are schematic diagrams showing process flows of alternative SOEC systems, according to various embodiments of the present disclosure.

### DETAILED DESCRIPTION

As set forth herein, various aspects of the disclosure are described with reference to the exemplary embodiments and/or the accompanying drawings in which exemplary embodiments of the invention are illustrated. This invention may, however, be embodied in many different forms and should not be construed as limited to the exemplary embodiments shown in the drawings or described herein. It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

In a high temperature fuel cell system, such as a solid oxide fuel cell (SOFC) system, an oxidizing flow is directed to the cathode (i.e., air) side of the fuel cell while a fuel flow is directed to the anode (i.e., fuel) side of the fuel cell. The oxidizing flow is typically air, while the fuel flow can be a hydrogen (H₂) or a hydrocarbon fuel, such as methane, natural gas, propane (LPG), ethanol, or methanol, or another suitable fuel, such as ammonia. The fuel cell, operating at a typical temperature between 700° C. and 950° C., enables the transport of negatively charged oxygen ions from the cathode flow stream to the anode flow stream, where the oxygen ions combine with either free hydrogen or hydrogen in a hydrocarbon or ammonia molecule to form water vapor and optionally combine with carbon monoxide to form carbon dioxide. The excess electrons from the negatively charged ions are routed back to the cathode side of the fuel cell through an electrical circuit completed between anode and cathode, resulting in an electrical current flow through the circuit.

Solid oxide electrolyzer cells (SOEC) produce hydrogen and oxygen from water. In a SOEC, a positive potential is applied to the air side of the cell and the oxygen ions are transported from the fuel side to the air side. Since the cathode and anode are reversed between SOFC and SOEC (i.e., SOFC cathode is SOEC anode, and SOFC anode is SOEC cathode), going forward, the SOFC cathode (SOEC anode) will be referred to as the air electrode, and the SOFC anode (SOEC cathode) will be referred to as the fuel electrode. During SOEC operation, water (e.g., steam) in the fuel stream is reduced (H₂O+2e→O²⁻+H₂) to form H₂ gas and O²⁻ ions, O²⁻ ions are transported through the solid electrolyte, and then oxidized on the air side (O²⁻ to O₂) to produce molecular oxygen.

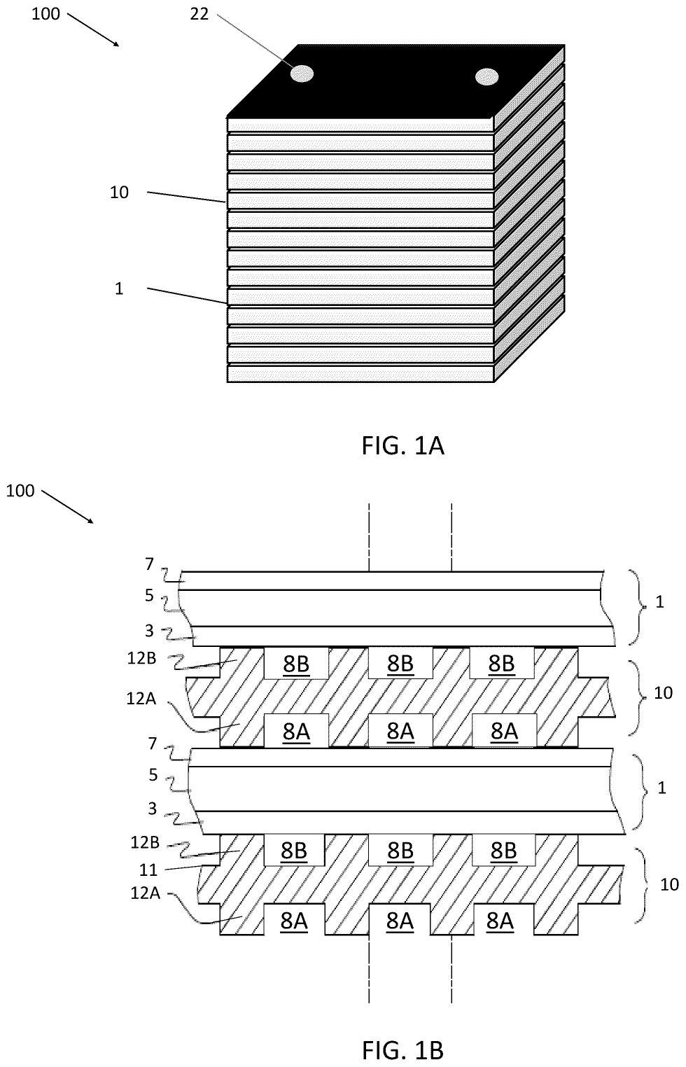

FIG. 1A is a perspective view of an electrochemical cell stack 100, and FIG. 1B is a side cross-sectional view of a portion of the stack 100 of FIG. 1A. Referring to FIGS. 1A and 1B, the stack 100 includes multiple electrochemical cells 1 that are separated by interconnects 10, which may also be referred to as gas flow separator plates or bipolar plates. The electrochemical cells 1 may be fuel cells or electrolyzer cells. Accordingly, the stack 100 may be referred to as a solid oxide fuel cell (SOFC) stack 100 or a solid oxide electrolyzer cell (SOEC) stack 100. Each electrochemical cell 1 includes an air electrode 3, a solid oxide electrolyte 5, and a fuel electrode 7. The stack 100 also includes optional internal fuel riser channels 22.

Each interconnect 10 electrically connects adjacent electrochemical cells 1 in the stack 100. In particular, an interconnect 10 may electrically connect the fuel electrode 7 of one electrochemical cell 1 to the air electrode 3 of an adjacent electrochemical cell 1. FIG. 1B shows that the lower electrochemical cell 1 is located between two interconnects 10.

Each interconnect 10 includes fuel ribs 12A that at least partially define fuel channels 8A and air ribs 12B that at least partially define air channels 8B. The interconnect 10 may operate as a gas-fuel separator that separates a fuel (e.g., hydrogen for a SOFC or steam for SOEC) flowing to the fuel electrode 7 of one electrochemical cell 1 in stack 100 from oxidant, such as air, flowing to the air electrode 3 of an adjacent electrochemical cell 1 in stack 100. At either end of the stack 100, there may be an air end plate or fuel end plate (not shown) for providing air or fuel, respectively, to the end electrode.

An electrochemical cell column may include one stack 100 or multiple stacks 100 arranged on one another. The column may be internally or externally manifolded for fuel and/or air. Optional anode splitter plates may be disposed between adjacent stacks 100 to provide fuel to the cells of each stack 100 as described in U.S. Pat. No. 10,511,047 B2, which is incorporated herein by reference in its entirety.

While a co-flow or counter-flow interconnect 10 is illustrated in FIG. 1B, in alternative embodiments, the interconnect 10 may comprise a crossflow interconnect in which the air and fuel channels extend perpendicular to each other, as described in U.S. Pat. No. 11,355,762 B2, which is incorporated herein by reference in its entirety. For example, such interconnects 10 may include two or more fuel holes per side of the interconnect.

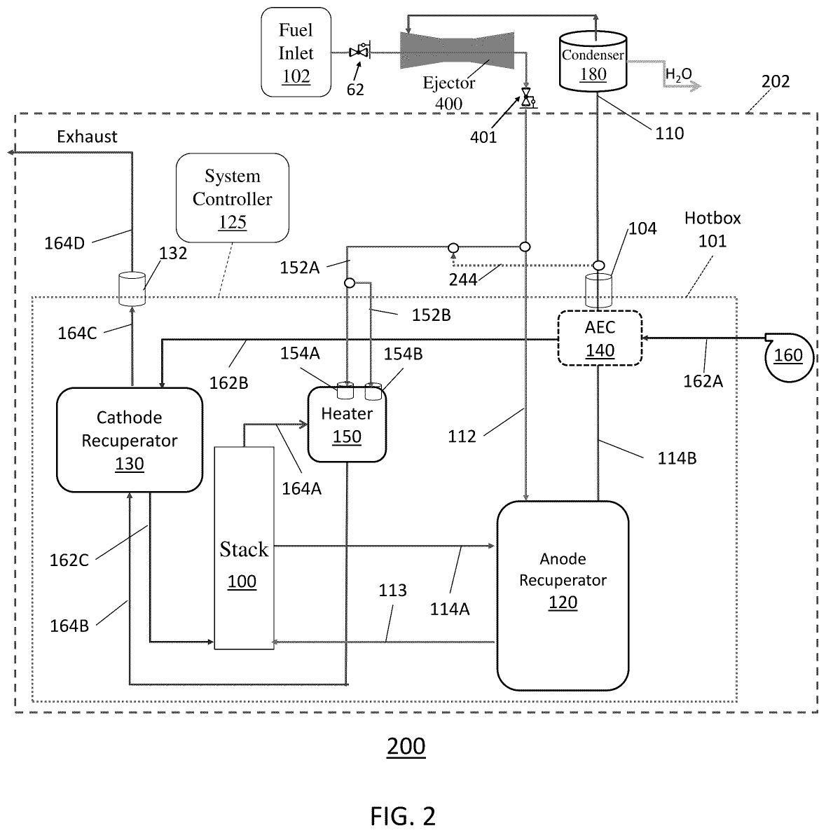

FIG. 2 is a schematic diagram of a solid oxide fuel cell system 200 that includes a power module 202 that uses hydrogen fuel, according to various embodiments of the present disclosure.

The power module 202 contains a hotbox 101. One or more electrochemical cell stacks 100 (or columns of stacks) are located in the hotbox 101. In one embodiment, the stacks 100 comprise solid oxide fuel cell stacks.

The power module 202 may also contain an anode recuperator 120 heat exchanger, a cathode recuperator 130 heat exchanger, and a startup heater 150. In some embodiments, the power module 202 may optionally include an anode exhaust cooler 140. The power module 202 may also include an air blower 160 (e.g., system blower), which may be disposed outside of the hotbox 101. However, the present disclosure is not limited to any particular location for each of the module components with respect to the hotbox 101.

The anode recuperator 120 receives fuel (e.g., H₂) from a fuel inlet (e.g., a hydrogen vessel and/or hydrogen line) 102 through a fuel inlet conduit 112. The fuel is heated in the anode recuperator 120 by fuel exhaust (e.g., anode exhaust) output from the stack 100, before being provided to the stack 100 by a stack fuel conduit 113. A first heater conduit 152A may fluidly connect the fuel inlet 102 to the startup heater 150. An optional second heater conduit 152B may also fluidly connect the fuel inlet 102 to the startup heater 150. Accordingly, the startup heater 150 may receive fuel provided by either or both of the first and second heater conduits 152A, 152B. The two inlets provide circumferential uniformity to the heaters 150. Alternatively, there may be only one heater conduit 152A or more than two heater conduits (e.g., three or four heater conduits). The conduits 112, 152A and 152B may be fluidly connected to the fuel inlet 102 using any suitable fluid connectors. For example, the fuel inlet conduit 112 may be connected to the fuel inlet 102, the first heater conduit 152A may be connected to the fuel conduit 112 at a first two way splitter downstream of the fuel inlet 102, and the second heater conduit 152B may be connected to the first heater conduit 152A at a second two way splitter downstream of the first two way splitter. Alternatively, a single three way splitter may split fuel from the fuel inlet 102 into all three conduits 112, 152A and 152B. Other fluid connections may also be used to connect the fuel inlet 102 to the three conduits 112, 152A and 152B. The first and second heater conduits 152A, 152B may be connected to the same or different fuel inlets of the startup heater 150. For example, the startup heater 150 may include a heating fuel inlet 154A and/or an ignition fuel inlet 154B connected to respective heater conduits 152A and 152B.

The startup heater 150 may also receive air exhaust (i.e., cathode exhaust) output from the stack 100 through an exhaust conduit 164A. The startup heater 150 may include a fuel oxidation catalyst (e.g., a noble metal catalyst) and/or heating element (e.g., resistive and/or radiative heating element). The heater 150 may generate heat by catalytically and/or thermally oxidizing received fuel using the air exhaust. Exhaust output from the startup heater 150 may be provided to the cathode recuperator 130 through exhaust conduit 164B. Exhaust output from the cathode recuperator 130 may be exhausted from the hotbox 101 through exhaust conduit 164C and exhaust outlet 132 in the hotbox 101. An exhaust conduit 164D may be configured to receive exhaust output from the exhaust outlet 132. In some embodiments, the exhaust conduit 164D may be part of or connected to a recycling manifold 110 configured to receive exhaust output from multiple hotboxes 100, as discussed in more detail below.

The air blower 160 may be configured to provide air (e.g., an air inlet stream) to the anode exhaust cooler 140 through air conduit 162A. Air flows from the anode exhaust cooler 140 to the cathode recuperator 130 through air conduit 162B. The air is heated in the cathode recuperator 130 by the air exhaust output from the stack 100 (or by startup heater 150 exhaust output if the fuel is also provided to the startup heater 150, where the fuel is oxidized by the air exhaust to form the oxidized fuel heater exhaust output). The heated air flows from the cathode recuperator 130 to the stack 100 through air conduit 162C.

Fuel exhaust (e.g., an anode exhaust stream generated in the stack 100) is provided to the anode recuperator 120 through fuel exhaust conduit 114A. The fuel exhaust may contain unreacted hydrogen fuel and water. Fuel exhaust output from the anode recuperator 120 may be provided to a fuel exhaust outlet 104 of the hotbox 101, by fuel exhaust conduit 114B. In some embodiments, the optional anode exhaust cooler 140 may be configured to cool the fuel exhaust flowing through the fuel exhaust conduit 114B by the inlet air stream from the air conduit 162A, prior to the fuel exhaust reaching the fuel exhaust outlet 104. The power module 202 may also optionally include a purge conduit 244 that fluidly connects the first heater conduit 152A to the fuel exhaust conduit 114B.

The power module 202 may further comprise a system controller 125 configured to control various elements of the module 202 and communicate with other components connected to the power module 202. The controller 125 may include a central processing unit configured to execute stored instructions. For example, the controller 125 may be configured to control the air flow through the power module 202 and to open and close the fuel flow to the power module 202.

In some embodiments, the fuel cell stacks 100 may be arranged in the hotbox 101 around a central column including the anode recuperator 120, the startup heater 150, and the optional anode exhaust cooler 140. In particular, the anode recuperator 120 may be disposed radially inward of the startup heater 150, and the anode exhaust cooler 140 may be mounted over the anode recuperator 120 and the startup heater 150.

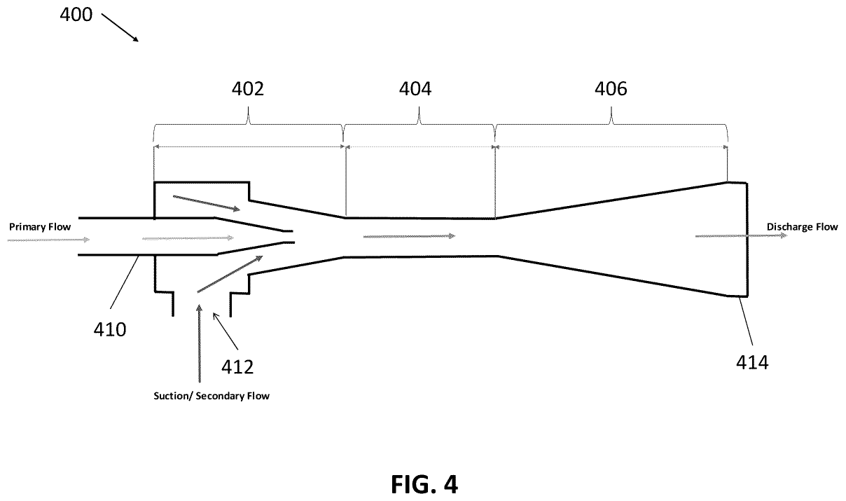

The system 200 may include a condenser 180 and a fluid ejector 400. In particular, the condenser 180 may be used to condense water vapor from anode exhaust output from the anode exhaust cooler 140 via the recycling manifold 110. The recycling manifold 110 may receive anode exhaust output from the hotbox 202 and provide the anode exhaust to the condenser 180 and then to a secondary inlet of the fluid ejector 400. As discussed in more detail below with regard to FIG. 4, the fluid ejector 400 is configured to mix the fresh fuel received at its primary inlet from the fuel source 102 with anode exhaust received at its secondary inlet from the recycling manifold 110 to form the fuel inlet stream (e.g., a mixed stream), which is provided to the anode recuperator 120 via the fuel inlet conduit 112 and then to the stack 100 via the stack fuel conduit 113. In one embodiment, the condenser 180 and the ejector 400 may be located outside the housing of the power module 202. An optional downstream pressure regulator 401 may be located downstream of the ejector 400 on the fuel inlet conduit 112. When the stack 100 current drops, the fuel flow through the ejector 400 will also drop, and the outlet pressure may become too high. The downstream pressure regulator 401 controls the outlet pressure from the ejector 400 to remain in a desired range. An optional upstream pressure regulator 62 may be located upstream of the ejector 400 on the fuel inlet conduit 112. The upstream pressure regulator 62 may be omitted if the system site fuel pressure is controlled to be in a desired range.

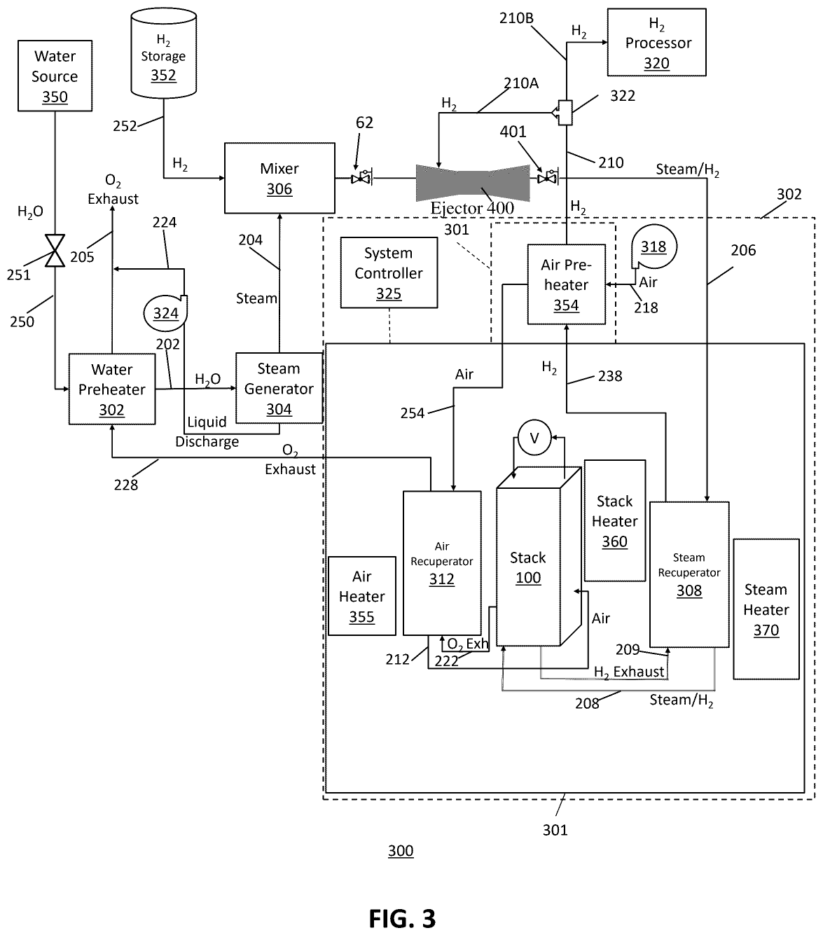

FIG. 3 is a schematic diagram of a solid oxide electrolyzer cell system 300 that includes a hydrogen generation module 302 that generates hydrogen from water, according to various embodiments of the present disclosure. The hydrogen generation module 302 may include a hotbox 301 containing one or more SOEC stacks 100 or columns, including multiple SOECs, as described above with respect to FIGS. 1A and 1B.

The system 300 may also include a steam generator 304, a steam recuperator heat exchanger 308, an air recuperator heat exchanger 312, an air blower 318, an air heater 355, a stack heater 360, and a steam heater 370. The system 300 may also optionally include at least one of an air pre-heater heat exchanger 354, a water preheater heat exchanger 302, a mixer 306, a hydrogen processor 320 and/or a hydrogen flow divider (e.g., splitter or valve) 322.

The system 300 may include a hotbox 301 that houses various components, such as the stack 100, the steam recuperator 308, the air recuperator 312, an air heater 355, a stack heater 360 and a steam heater 370. In some embodiments, the hotbox 301 may include multiple stacks 100 or multiple columns of stacks 100. The water preheater 302 and the steam generator 304 may be located external to the hotbox 301, as shown in FIG. 3. Alternatively, the water preheater 302 and/or the steam generator 304 may be located inside the hotbox 301. In another alternative embodiment, the system 300 may utilize an external steam source, in which case the water preheater 302 and the steam generator 304 may be omitted.

During operation, the stack 100 may be provided with steam (e.g., steam inlet stream) and electric power (e.g., current or voltage) from an external power source. In particular, the steam may be provided to the fuel electrodes 7 of the electrolyzer cells 1 of the stack 100, and the power source may apply a voltage between the fuel electrodes 7 and the air electrodes 3, in order to electrochemically split water (e.g., steam) molecules and generate hydrogen and oxygen. Air may also be provided to the air electrodes 3, in order to sweep the oxygen from the air electrodes 3. As such, the stack 100 may output a hydrogen stream and an oxygen-rich exhaust stream, such as an oxygen-rich air stream (“oxygen exhaust stream”).

In order to generate the steam, water may be provided to the system 300 from a water source 350. The water source 350 may include a municipal water supply (e.g., water pipe) and/or a water storage tank. The water may be deionized (DI) water that is deionized as much as is practical (e.g., <0.1 μS/cm), in order to prevent and/or minimize scaling during vaporization. In some embodiments, the water source 350 may include one or more deionization beds (e.g., downstream of the water pipe or tank). The water source 350 may provide the water to the system 300 via a water inlet conduit 250. In various embodiments, the water inlet conduit 250 may include a water flow control device 251 such as a valve, a mass flow controller, a positive displacement pump, a water flow meter, or the like, in order to provide a desired water flow rate to the system 300.

If the system 300 includes the water preheater 302, the water may be provided from the water source 350 to the water preheater 302 through the water inlet conduit 250. The water preheater 302 may be a heat exchanger configured to heat the water using heat recovered from the oxygen exhaust stream from the stack 100. Preheating the water may reduce the total power consumption of the system 300 per unit of hydrogen generated. In particular, the water preheater 302 may recover heat from the oxygen exhaust stream that may not be recoverable by the air recuperator 312, as discussed below. The water preheater may heat the water to a temperature above 50° C., such as a temperature of about 70° C. to 80° C. The oxygen exhaust stream may be output from the water preheater 302 at a temperature above 80° C., such as above 100° C., such as a temperature of about 120° C. to 140° C.

The water output from the water preheater 302 (or from the water source 350 if the water preheater 302 is omitted) may be provided to the steam generator 304 through a water conduit 202. The steam generator 304 may be configured to heat the water to convert the water into steam. The steam generator 304 may include a heating element to vaporize the water and generate steam. For example, the steam generator 304 may include an AC or DC resistance heating element or an induction heating element. Alternatively, the steam generator 304 may comprise a heat exchanger which is located inside the hotbox 301 and which is heated by one or more hot exhaust streams flowing through the hotbox 301. The steam generator 304 heats the water above 100° C. to generate steam, such as a temperature of about 120° C. to 145° C.

The steam generator 304 may include multiple zones/elements that may or may not be mechanically separate. For example, the steam generator 304 may include a pre-boiler to heat the water up to or near to the boiling point. The steam generator 304 may also include a vaporizer configured to convert the pre-boiled water into steam. The steam generator 304 may also include a deaerator to provide a relatively small purge of steam to remove dissolved air from the water prior to bulk vaporization. The steam generator 304 may also include an optional superheater configured to further increase the temperature of the steam generated in the vaporizer. The steam generator 304 may include a demister pad located downstream of the heating element and/or upstream from the super heater. The demister pad may be configured to minimize entrainment of liquid water in the steam output from the steam generator 304 and/or provided to the superheater.

If the steam product is superheated, it will be less likely to condense downstream from the steam generator 304 due to heat loss to ambient conditions. Avoidance of condensation is preferable, as condensed water is more likely to form slugs of water that may cause significant variation of the delivered mass flow rate with respect to time. It may also be beneficial to avoid excess superheating, in order to limit the total power consumption of the system 300. For example, the steam may be superheated by an amount ranging from about 10° C. to about 100° C.

In some embodiments, a small amount of liquid water (e.g., from about 0.5% to about 2% of incoming water) may be periodically or continuously discharged from the steam generator 304 via a liquid discharge conduit 224. In particular, the discharged liquid water may include scale and/or other mineral impurities that may accumulate in the steam generator 304 while vaporizing water to generate steam. Therefore, this discharged liquid water is not desirable for being recycled into the water inlet stream from the water source 350. This liquid discharge may be mixed with the hot oxygen exhaust stream output from the water preheater 302 into an exhaust conduit 205. If the hot oxygen exhaust stream has a temperature above 100° C., such as 120 to 140° C., the liquid water discharge may be evaporated by the hot oxygen exhaust stream, such that no liquid water is required to be discharged from the system 300. The system 300 may optionally include a water pump 324 configured to pump and regulate the liquid water discharge in the liquid discharge conduit 224 output from the steam generator 304 into the exhaust conduit 205 from the water preheater 302. Optionally, a flow regulator, such as proportional solenoid valve, may be added to the liquid discharge conduit 224 in addition to the pump 324 to additionally regulate the flow of the liquid water discharge.

Blowdown from the steam generator 304 may be beneficial for long term operation, as the water will likely contain some amount of mineralization after deionization. Typical liquid blowdown may be on the order of 1%. The blowdown may be continuous, or may be intermittent, e.g., ten times the steady state flow for 6 seconds out of every minute, five times the steady state flow for 1 minute out of every 5 minutes, etc. The need for a water discharge stream can be eliminated by pumping the blowdown into the hot oxygen exhaust. In this case, the pump 324 and liquid discharge conduit 224 may be omitted.

The steam output from the steam generator 304 may be provided to the steam recuperator 308 via a steam conduit 204. However, if the system 300 includes the optional mixer 306, the steam may be provided to the mixer 306 prior to being provided to the steam recuperator 308. In particular, the steam may include small amounts of dissolved air and/or oxygen. The mixer 306 may be configured to mix the steam with hydrogen gas, in order to maintain a reducing environment in the stack 100, and in particular, at the fuel electrodes 7.

The mixer 306 may be configured to mix the steam with hydrogen received from a hydrogen storage device (e.g., hydrogen storage vessel) 352 and/or with a portion of the hydrogen and stream recycle stream output from the stack 100. The hydrogen addition rate may be set to provide an amount of hydrogen that exceeds an amount of hydrogen needed to react with an amount of oxygen dissolved in the steam. The hydrogen addition rate may either be fixed or set to a constant water to hydrogen ratio. However, if the steam is formed using water that is fully deaerated, the mixer 306 and/or hydrogen addition into the steam may optionally be omitted.

In some embodiments, the hydrogen may be provided to the mixer 306 during system startup and shutdown modes, and optionally during steady-state operation modes. For example, during the startup and shutdown modes (or other modes where the system 300 is not generating hydrogen, such as a fault mode), the hydrogen may be provided to the mixer 306 from the hydrogen storage device 352 via a stored hydrogen conduit 252.

During the steady-state operating mode, the hydrogen flow from the hydrogen storage device 352 may be stopped (e.g., by shutting off the outlet valve from the hydrogen storage device). Instead, a first portion of a hydrogen exhaust stream (e.g., the hydrogen and steam product steam) generated by the stack 100 is diverted to the ejector 400 through the hydrogen recycle manifold 210A. In particular, the system 300 may include a hydrogen flow divider 322, such as a splitter and/or valve, configured to selectively divert a portion of the hydrogen exhaust stream flowing through the hydrogen product manifold 210 to the secondary entrance of the ejector 400 via the hydrogen recycle manifold 210A during the steady-state mode operation.

The mixed steam and hydrogen inlet stream is provided from the mixer 306 through the primary entrance of the ejector 400 into a steam recuperator heat exchanger 308 via a steam and hydrogen conduit 206. The mixed steam and hydrogen inlet stream in conduit 206 may have a temperature above 100° C., such as 120° C. to 140° C. The mixed steam and hydrogen inlet stream is heated in the steam recuperator 308 by the hydrogen exhaust (i.e., the hydrogen and steam product stream) provided from the stack 100. The hydrogen exhaust may be provided from the stack 100 to the steam recuperator 308 via a hydrogen outlet conduit 209. The heated mixed steam and hydrogen inlet stream is provided from the steam recuperator heat exchanger 308 into the fuel side inlet of the stack 100 via the fuel inlet conduit 208. The mixed steam and hydrogen inlet stream in the fuel inlet conduit 208 may have a temperature above 500° C., such as 550° C. to 600° C. In an alternative embodiment, the hydrogen flow from the hydrogen storage device 352 may be provided downstream of the ejector 400. In this alternative embodiment, the mixer 306 may be located downstream of the ejector 400 and the stored hydrogen conduit 352 is connected to the mixer 306 downstream of the ejector 400.

The hydrogen exhaust is output from the hotbox 301 (e.g., from the steam recuperator 308 and/or the optional air preheater 354) into the hydrogen product manifold 210 at a temperature of 150° C. to 250° C. A second portion of the hydrogen exhaust that is not diverted by the hydrogen flow divider 322 into the ejector 400 via the hydrogen recycling manifold 210A continues through the downstream portion 210B of the hydrogen product manifold 220 into the hydrogen processor 320. The hydrogen exhaust may be compressed and/or purified in the hydrogen processor 320. The hydrogen processor 320 may include a high temperature hydrogen pump that operates at a temperature of from about 320° C. to about 200° C., in order to capture from about 70% to about 90% of the hydrogen from the hydrogen exhaust. The removed hydrogen is stored and/or provided for one or more end uses. In one embodiment, the hydrogen processor 320 includes an electrochemical hydrogen pump, a liquid ring compressor, a diaphragm compressor or combination thereof. For example, the hydrogen processor may include a series of electrochemical hydrogen pumps, which may be disposed in series and/or in parallel with respect to a flow direction of the hydrogen exhaust, in order to compress the hydrogen exhaust. The final product from compression may still contain traces of water. As such, the hydrogen processor 320 may optionally include a dewatering device, such as a condenser, a temperature swing adsorption reactor or a pressure swing adsorption reactor, to remove this residual water, if necessary.

The air recuperator heat exchanger 312 may be provided with ambient air by an air blower 318 via an air inlet conduit 218 and an optional preheated air conduit 254. The oxygen exhaust output from the stack 100 may be provided to the air recuperator 312 via an oxygen outlet conduit 222. The air recuperator 312 may be configured to heat the air using heat extracted from the stack oxygen exhaust (i.e., the oxygen enriched air). The air inlet stream may be heated in the air recuperator 312 to a temperature above 500° C., such as 550° C. to 600° C. The heated air inlet stream is provided from the air recuperator 312 to the air inlet of the stack 100 via the stack air inlet conduit 212.

The oxygen exhaust is output from the air recuperator 312 to the water preheater 302 via the oxygen exhaust conduit 228 at temperature above 200° C., such as 250° C. to 350° C. The oxygen exhaust is output from the water preheater 302 via the exhaust conduit 205 at temperature of 100° C. to 150° C.

According to various embodiments, the system 300 may include an optional air preheater heat exchanger 354 disposed outside or inside of the hotbox 301. In particular, the air preheater 354 may be configured to preheat the air inlet stream provided to the hotbox 301 by the air blower 318 via the air inlet conduit 218 using heat in the hydrogen exhaust (i.e., the hydrogen and steam product stream) from the stack 100. The air may be preheated in the air preheater 354 to a temperature above 100° C., such as 150° C. to 250° C. The hydrogen exhaust may be provided from the steam recuperator 308 to the air preheater 354 via a hydrogen conduit 238. In an optional embodiment, the ejector 400 may allow the steam recycle temperature in the hydrogen recycle manifold 210A to be higher than in a system where the steam recycle is provided by a blower. Thus, the ejector 400 permits use of a higher temperature steam if it is available, compared to a using a recycle blower.]

The air heater 355 may be located radially outward of the air recuperator 312 in the hotbox 301. The air heater 355 may further heat the air inlet stream flowing through the air recuperator 312 and/or the stack air inlet conduit 312. The stack heater 360 may be located radially inward of the stacks 100 or columns and radially outward of the steam recuperator 308 in the hotbox 301. The stack heater 360 may heat the stacks 100 or columns. The steam heater 370 may be located radially inward of the steam recuperator 308 in the center of the hotbox 301. The steam heater 370 may heat the steam inlet stream flowing through the steam recuperator 308 and/or the fuel inlet conduit 208.

The stack heater 360 may have two or more heating regions. For example, the stack heater 360 may include a lower heating region and an upper heating region. Heating elements included in each of the regions may be independently connected to a voltage source. The heating elements of each region may be independently controlled by the system controller 325, in order to independently control an amount of heat generated by each heating region. As such, the stack heater 360 may radiate different amounts of heat to different portions of the stacks 100 or columns 101 and/or different portions of the central column 320. The system may include temperature sensors to monitor the various zones in order to provide feedback to the system controller 325 so that it can adjust the amount of heating provided to the different regions accordingly.

According to various embodiments, the system 300 may include a system controller 325, such as a central processing unit, that is configured to control the operation of the system 300. For example, the controller 325 may be wired or wirelessly connected to various elements of the system 300 to control the same and communicate with other components connected to system 300. The optional upstream pressure regulator 62 and/or optional downstream pressure regulator 401 may be provided on the steam and hydrogen conduit 206 upstream and/or downstream of the fluid ejector 400, respectively. The upstream pressure regulator 62 may be omitted if the system site fuel pressure is controlled to be in a desired range.

FIG. 4 is a schematic diagram of a fluid ejector 400 that may be utilized in systems 200 or 300 of FIGS. 2 and 3, according to various embodiments of the present disclosure. Referring to FIG. 4, the fluid ejector 400 may include a suction chamber 402, a mixing chamber 404, and a diffusion chamber 406 that are fluidly connected. The suction chamber 402 may include an inlet nozzle (e.g., the primary inlet) 410 and the secondary inlet 412, and the diffusion chamber may include an outlet 414.

The inlet nozzle 410 may be configured to inject a primary fluid stream into the suction chamber 402. The primary fluid stream may comprise a fuel stream of fresh fuel (e.g., hydrogen) provided from the fuel inlet 102 of FIG. 2, or a steam inlet stream provided from the steam generator 304 of FIG. 3 (or mixer 306 as the case may be). The inlet nozzle 410 may be configured to increase the velocity of and/or reduce the pressure of the primary fluid stream, such that the primary fluid stream is injected to the suction chamber 402 at a higher velocity and a lower pressure than the primary fluid stream is provided to the inlet nozzle 410. The relatively high velocity of the primary fluid stream may reduce the pressure in the suction chamber 402.

The secondary inlet 412 may be configured to provide a secondary fluid stream to the suction chamber 402. For example, the secondary fluid stream may comprise the anode exhaust stream received via the manifold 110 from the hotbox 201 of FIG. 2 or a hydrogen exhaust stream received via the manifold 210A from the hotbox 301 of FIG. 3. The primary fluid stream may be provided to the inlet nozzle 410 at a higher pressure than the secondary fluid stream is provided to the secondary inlet 412. Within the suction chamber 402, the velocity of the secondary fluid stream may be increased due to interaction with the high-velocity, turbulent, primary fluid stream.

In some embodiments, the internal cross-sectional area and/or diameter of the suction chamber 402 may decrease adjacent to the mixing chamber 404, which may further accelerate both the primary and secondary fluid streams. For example, the internal cross-sectional area of the suction chamber 402 may decrease as the distance to the mixing chamber 404 decreases. In one embodiment, the diffusion chamber 406 comprises a diverging nozzle, and the mixing chamber 404 is narrower (e.g., has a smaller diameter) than the diffusion chamber 406 and the suction chamber 402.

The primary and secondary fluid streams may flow into the mixing chamber 404 where the fluid streams are mixed to form a mixed stream. The mixed stream may then flow into the diffusion chamber 406. The diffusion chamber 406 may be configured to reduce the velocity and/or increase the pressure of the mixed stream. For example, the internal cross-sectional area and/or diameter of the diffusion chamber 406 may increase as the distance from the mixing chamber 404 increases. Accordingly, the mixed stream may be provided to the outlet 414 of the diffusion chamber 406 at a pressure and/or velocity that is suitable for operation of an electrochemical cell stack.

Accordingly, the fluid ejector 400 may operate based on Bernoulli's principle, wherein as the velocity of a fluid through a conduit increases, its pressure decreases, and vice versa. For example, the reduced pressure generated in the suction chamber 402 by the inlet nozzle 410 may generate suction that pulls the secondary fluid stream into the fluid ejector 400. The fluid ejector 400 may also reduce the velocity and/or increase the pressure of the fuel mixture output to the stack 100.

In other electrochemical cell systems, a recycle blower is needed to maintain a required stack inlet pressure. However, recycle blowers consume power and require relatively complicated moving parts. In addition, blowers may struggle with the high temperatures present in high-temperature fuel cell operating conditions. In contrast, the fluid ejector 400 may allow for the omission of a recycle blower, and thereby improve system power efficiency and reliability, while also reducing manufacturing and maintenance costs.

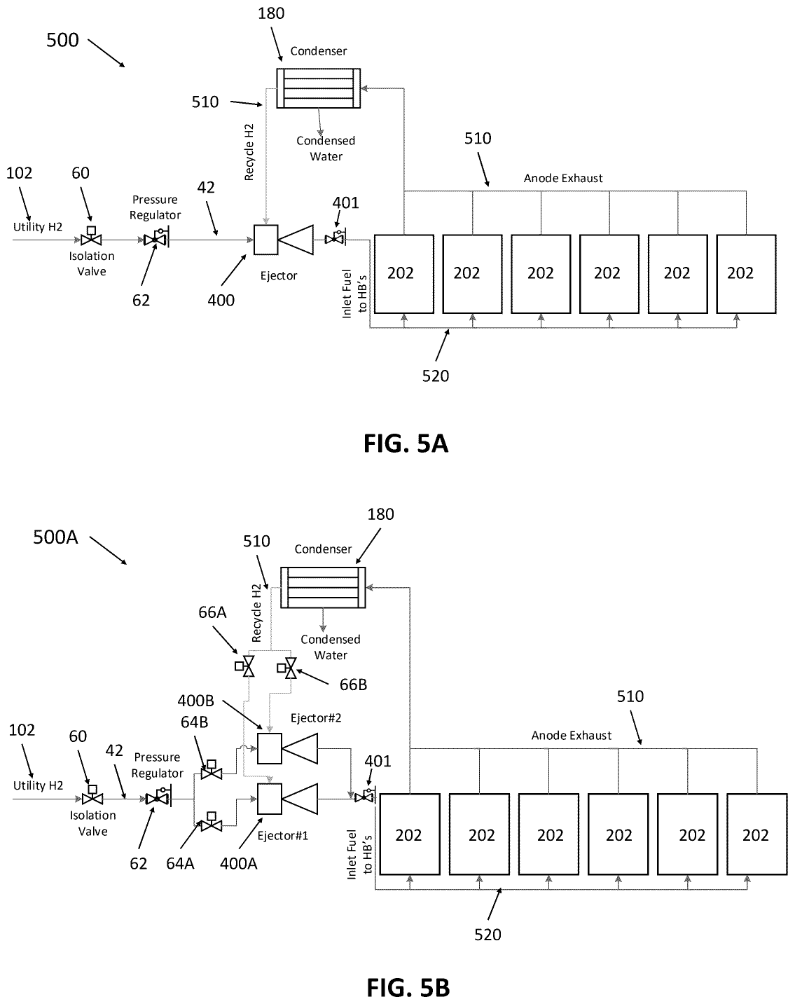

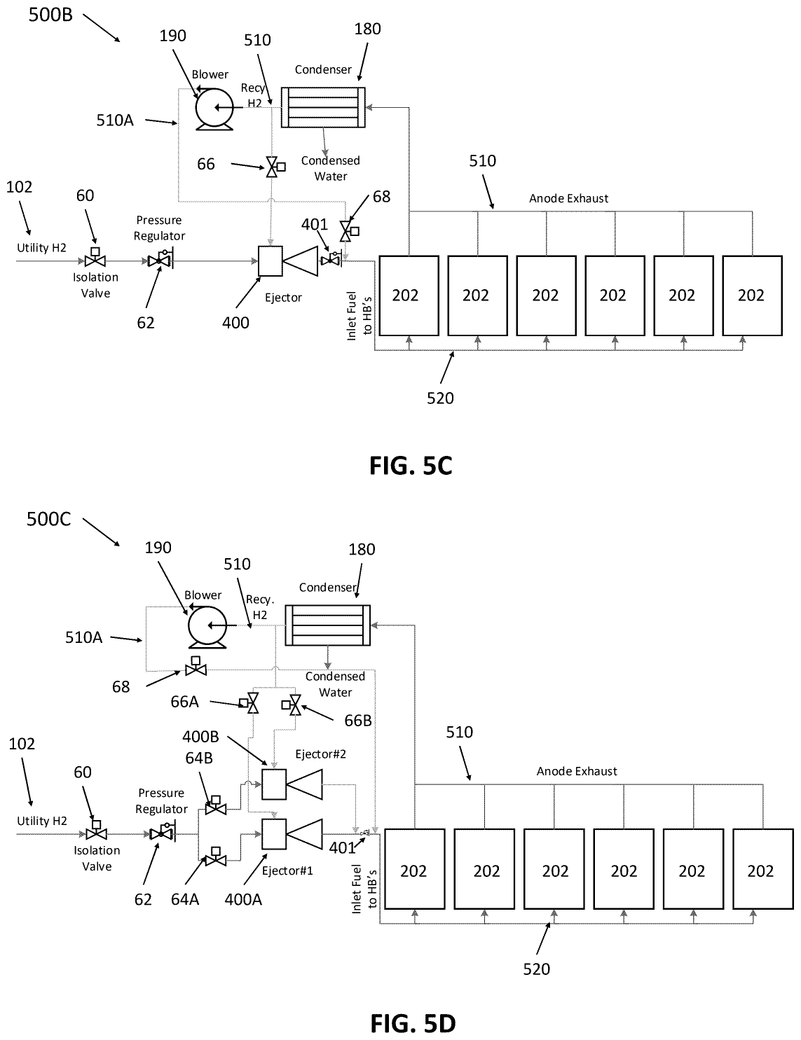

FIG. 5A is a schematic diagram showing a process flow in a fuel cell system 500, such as a SOFC system, according to various embodiments of the present disclosure. The system 500 may be similar to the system 200 of FIG. 2. Accordingly, only the differences therebetween will be discussed in detail.

Referring to FIGS. 2, 4, and 5A, the system 500 may be configured to operate using hydrogen as a fuel and may include multiple power modules 202 and corresponding components housed therein. The power modules 202 may be fluidly connected to a secondary inlet of a fluid ejector 400 by a recycling manifold 510 or conduit (e.g., an anode exhaust recycling manifold 110 shown in FIG. 2). The power modules 202 may be fluidly connected to an outlet 414 of the fluid ejector 400 by an inlet manifold 520 or conduit (e.g., fuel manifold). A condenser 180 may be disposed on the recycling manifold 510, such that a hydrogen outlet of the condenser 180 is fluidly connected to a secondary inlet 412 of the fluid ejector 400. The water outlet of the condenser 180 may be connected to a water drain. An inlet nozzle 410 of the fluid ejector 400 may be fluidly connected to a fuel inlet conduit 42 or manifold. The fuel inlet conduit 42 may be fluidly connected to the fuel inlet 102, such as a hydrogen storage vessel or a hydrogen line. An isolation valve 60 and an optional pressure regulator 62 may be located on the fuel inlet conduit 42. The upstream pressure regulator 62 upstream of the fluid ejector 400 may be omitted if the downstream pressure regulator 401 is located downstream of the fluid ejector 400 and/or if the system site fuel pressure is controlled to be in a desired range.

Accordingly, the condenser 180 may operate to remove water from anode exhaust generated by fuel cell stacks 100 disposed in multiple power modules 202. The fluid ejector 400 may operate to pull the anode exhaust through the condenser 180 and/or the recycling manifold 510.

FIG. 5B is a schematic diagram showing a process flow in an alternative SOFC system 500A, according to various embodiments of the present disclosure. The system 500A may be similar to the system 500. Accordingly, only the differences therebetween will be discussed in detail.

Referring to FIG. 5B, the system 500A may include multiple fluid ejectors 400 to maintain a desired pressure in a fuel inlet stream provided to the power modules 202. For example, the system 500A may include a first fluid ejector 400A, a second fluid ejector 400B, a first nozzle valve 64A, a second nozzle valve 64B, a first inlet valve 66A, and a second inlet valve 66B. During steady-state operations, the valves 64A, 64B, 66A, 66B, may be opened to provide sufficient fuel and anode exhaust flow through the manifolds 510, 520. In particular, both fluid ejectors 400A, 400B may be operated to provide a mixed steam comprising fresh fuel (e.g., hydrogen) and anode exhaust to the power modules 202 via the inlet manifold 520.

However, one or more of the power modules 202 may be taken offline during servicing. As such, the fuel and anode exhaust flow rates of the system 500A may be correspondingly reduced. Therefore, one of the fluid ejectors 400A, 400B may be isolated from the fuel and anode exhaust flows, by closing the corresponding valves 64A and 66A or 64B and 66B.

FIG. 5C is a schematic diagram showing a process flow in an alternative SOFC system 500B, according to various embodiments of the present disclosure. The system 500B may be similar to the system 500. Accordingly, only the differences therebetween will be discussed in detail.

Referring to FIG. 5C, the system 500B may include a recycle blower 190, an inlet valve 66, and a blower valve 68. An inlet of the recycle blower 190 may be fluidly connected to an outlet of the condenser 180 by the recycling manifold 510. The recycling manifold 510 may include a bypass conduit 510A that fluidly connects an outlet of the recycle blower 190 directly to the inlet manifold 520. In other words, the bypass conduit 510A may bypass the fluid ejector 400, such that at least a portion of the anode exhaust is provided directly to the inlet manifold 520, downstream of the fluid ejector 400 with respect to a fluid flow direction through the inlet manifold 520. The blower valve 68 may be configured to selectively close the bypass conduit 510A.

During steady-state operation, the inlet valve 66 may be open and the blower valve 68 may be closed, such that all of the anode exhaust output from the power modules 202 is provided to the fluid ejector 400. During non-steady state and/or transition operating modes, the blower valve 68 may be opened and the recycle blower 190 may be operated to bypass the fluid ejector 400 and/or increase anode exhaust flow to the inlet manifold 520. The inlet valve 66 may be closed to prevent fuel backflow from the fluid ejector 400 into the recycle blower 190. In some embodiments, the system 500B may include additional blowers 190 and corresponding valves 66, 68. The coordination of the opening and closing of the various valves during different operating modes can be accomplished by the system controller 125

FIG. 5D is a schematic diagram showing a process flow in an alternative SOFC system 500C, according to various embodiments of the present disclosure. The system 500C may include a combination of the components of the systems 500A and 500B. Accordingly, only the differences therebetween will be discussed in detail.

Referring to FIG. 5D, the system 500C may include at least one condenser 180, at least two fluid ejectors 400A, 400B, at least one recycle blower 190, and corresponding valves 64A, 64B, 66A, 66B, 68 to control fuel and anode exhaust flow therethrough. Accordingly, fluid flows through the fluid ejectors 400A, 400B, and the recycle blower 190 may be independently controlled.

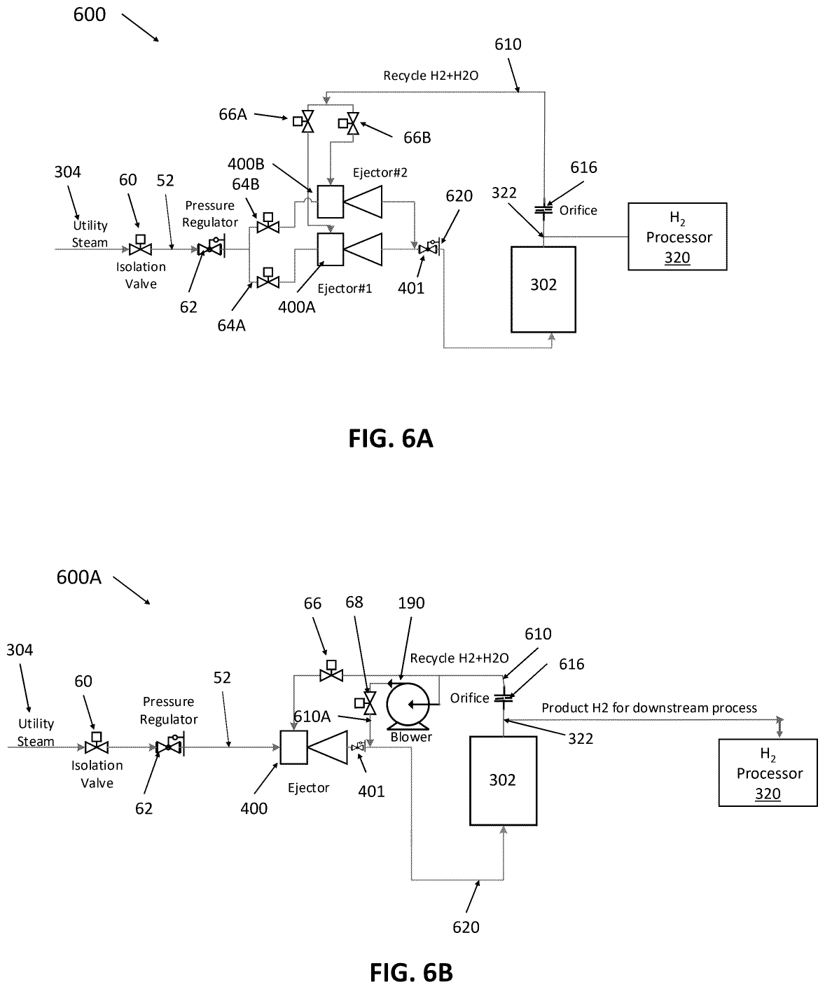

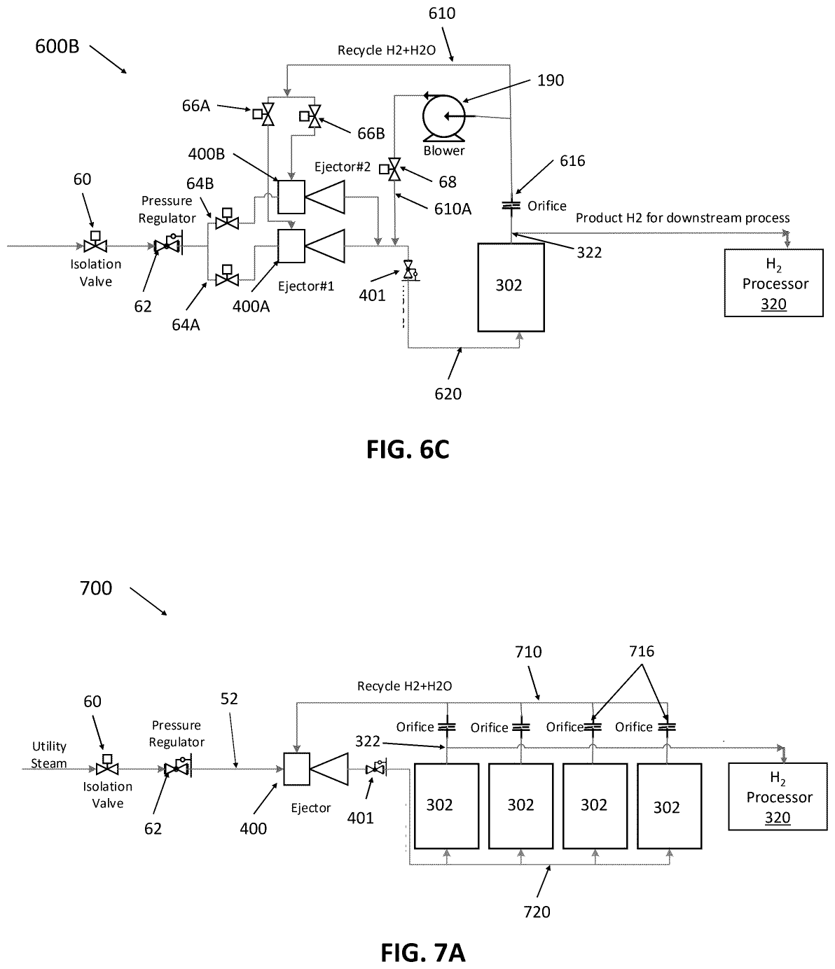

FIG. 6A is a schematic diagram showing a process flow in a SOEC system 600, according to various embodiments of the present disclosure. The system 600 may be similar to the system 300 of FIG. 3. Accordingly, only the differences therebetween will be discussed in detail.

Referring to FIG. 6A, the system 600 may include multiple fluid ejectors 400 to maintain a desired pressure in a steam stream provided to the hydrogen generation module 302. For example, the system 600 may include a first fluid ejector 400A, a second fluid ejector 400B, a first nozzle valve 64A, a second nozzle valve 64B, a first inlet valve 66A, and a second inlet valve 66B. The hydrogen generation module 302 may be fluidly connected to the fluid ejectors 400A, 400B by a recycling manifold 610 or conduit and an inlet manifold 620 or conduit (e.g., steam manifold). In particular, the recycling manifold 610 may be configured to provide hydrogen and/or water output from the hydrogen generation module 302 to the fluid ejectors 400A, 400B and/or to a hydrogen processor 320. In particular, the recycling manifold 610 may include an orifice 616 and a hydrogen flow divider 322, such as a splitter and/or valve, configured to divert at least a portion of the generated hydrogen stream to the fluid ejectors 400A, 400B during steady-state operation while the remainder of the generated hydrogen stream is provided to the hydrogen processor 320. The optional orifice 616 is located downstream from the hydrogen flow divider 322 and is sized based on inlet pressure needed to meet the desired flow rate. The orifice 616 is used to limit the flow of the recycled hydrogen to the fluid ejectors 400A, 400B. Alternatively, the orifice 616 may be omitted.

During steady-state operation, the valves 64A, 64B, 66A, 66B, may be opened to provide sufficient fuel and anode exhaust flow through the manifolds 610, 620. In particular, both fluid ejectors 400A, 400B may be operated to provide a mixed steam comprising steam and hydrogen to the hydrogen generation module 302 via the inlet manifold 620.

In some embodiments, hydrogen and steam flow to at least one of the fluid ejectors 400A, 400B may be reduced or stopped by closing or partially closing the corresponding valves 64A, 64B, 66A, 66B. For example, hydrogen and steam flow may be reduced or stopped during a transition operation, servicing, and/or during low-load steady state operation.

FIG. 6B is a schematic diagram showing a process flow in an alternative SOEC system 600A, according to various embodiments of the present disclosure. The system 600A may be similar to the system 300 of FIG. 3. Accordingly, only the differences therebetween will be discussed in detail.

Referring to FIG. 6B, the system 600A may include a recycle blower 190, an inlet valve 66, and a blower valve 68. The recycle blower 190 may be fluidly connected to the recycling manifold 610 and the inlet manifold 620. In particular, the recycling manifold 610 may include a bypass conduit 610A that fluidly connects an outlet of the recycle blower 190 directly to the inlet manifold 620, downstream of the fluid ejector 400 with respect to a fluid flow direction through the inlet manifold 620. The blower valve 68 may be configured to selectively close the bypass conduit 610A.

During non-steady state and/or transition operations, the blower valve 68 may be opened and the recycle blower 190 may be operated to bypass the fluid ejector 400 and increase hydrogen flow to the inlet manifold 620. The inlet valve 66 may be closed or partially closed to prevent backflow from the fluid ejector 400 into the recycle blower 190. In one embodiment, the recycle blower 190 may have a longer life span compared to a comparative embodiment where the ejector 400 is omitted, because the recycle blower 190 operates intermittently (e.g., during non-steady or transition operations) in the embodiment in which the ejector 400 is present, compared to being operated continuously during system operation in the comparative embodiment in which the ejector 400 is omitted.

FIG. 6C is a schematic view showing a process flow in an alternative SOFC system 600B, according to various embodiments of the present disclosure. The system 600B may include a combination of the components of the systems 600 and 600A. Accordingly, only the differences therebetween will be discussed in detail.

Referring to FIG. 6C, the system 600B may include at least two fluid ejectors 400A, 400B, a recycle blower 190, and the corresponding valves 64A, 64B, 66A, 66B, 68 to control steam and hydrogen flow therethrough. Accordingly, fluid flow through the fluid ejectors 400A, 400B, and the recycle blower 190 may be independently controlled by adjusting the valves 64A, 64B, 66A, 66B, 68, and/or controlling the operation of the recycle blower 190.

The optional pressure regulator 62 in the systems 600, 600A and/or 600B of FIGS. 6A, 6B and/or 6C may be replaced with a flow control valve (e.g., a valve similar to the valve 251 shown in FIG. 3 which controls the steam flow rate) if the system site control pressure of the steam is regulated. Alternatively, a flow control valve may be used in fluid series with the pressure regulator 62.

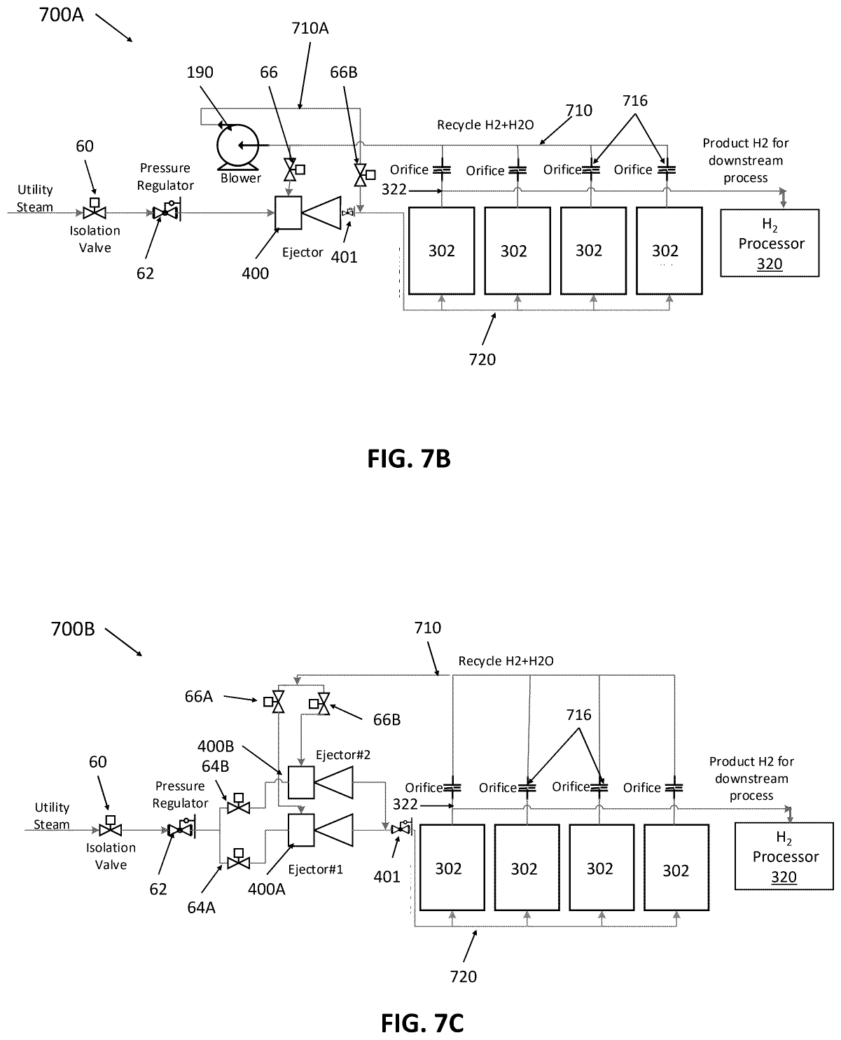

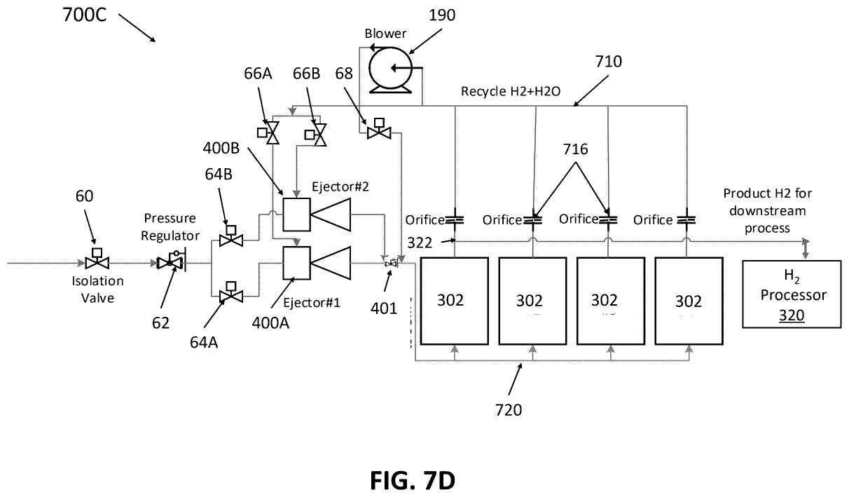

FIG. 7A is a schematic diagram showing a process flow in an SOEC system 700, according to various embodiments of the present disclosure. The system 700 may be similar to the system 300 of FIG. 3. Accordingly, only the differences therebetween will be discussed in detail.

Referring to FIGS. 3, 4, and 7A, the system 700 may include multiple hydrogen generation modules 302 and at least one fluid ejector 400. The hydrogen generation modules 302 may be fluidly connected to a secondary inlet of the fluid ejector 400 by a recycling manifold 710 (e.g., a hydrogen manifold) or conduit and may be fluidly connected to an outlet 414 of the fluid ejector 400 by an inlet manifold 720 or conduit (e.g., steam manifold).

The recycling manifold 710 may be configured to provide hydrogen and/or water output from the hydrogen generation modules 302 to the secondary inlet 412 the fluid ejector 400 and/or to a hydrogen processor 320. In particular, the recycling manifold 710 may include an orifice 716 and a hydrogen flow divider 322, as described above. The system 700 may also include an inlet manifold 720 configured to provide steam and hydrogen from an outlet 414 of the fluid ejector 400 to the hydrogen generation modules 302.

FIG. 7B is a schematic diagram showing a process flow in an alternative SOEC system 700A, according to various embodiments of the present disclosure. The system 700A may be similar to the system 700 of FIG. 7A. Accordingly, only the differences therebetween will be discussed in detail.

Referring to FIG. 7B, the system 700A may include a recycle blower 190, an inlet valve 66, and a blower valve 68. The recycle blower 190 may be fluidly connected to the recycling manifold 710 and the inlet manifold 720. In particular, the recycling manifold 710 may include a bypass conduit 710A that fluidly connects an outlet of the recycle blower 190 directly to the inlet manifold 720, downstream of the fluid ejector 400 with respect to a fluid flow direction through the inlet manifold 720. The blower valve 68 may be configured to selectively close the bypass conduit 710A.

During non-steady state and/or transition operations, the blower valve 68 may be opened and the recycle blower 190 may be operated to bypass the fluid ejector 400 and increase hydrogen flow to the inlet manifold 720. The inlet valve 66 may be closed or partially to prevent backflow from the fluid ejector 400 into the recycle blower 190.

FIG. 7C is a schematic diagram showing a process flow in an alternative SOEC system 700B, according to various embodiments of the present disclosure. The system 700B may be similar to the system 700 of FIG. 7A. Accordingly, only the differences therebetween will be discussed in detail.

Referring to FIG. 7C, the system 700B may include multiple fluid ejectors 400 to maintain a desired pressure in a steam stream provided to the multiple hydrogen generation modules 302. For example, the system 600 may include a first ejector 400A, a second ejector 400B, a first nozzle valve 64A, a second nozzle valve 64B, a first inlet valve 66A, and a second inlet valve 66B. The hotboxes 302 may be fluidly connected to the fluid ejectors 400A, 400B by a recycling manifold 710 or conduit and an inlet manifold 720 or conduit. In particular, the recycling manifold 710 may be configured to provide hydrogen and/or water output from the hotbox 101 to the fluid ejectors 400A, 400B and/or to downstream process such as a hydrogen processor. In particular, the recycling manifold 710 may include diverters 716, such as a splitter, pump, blower, orifice, and/or valve, configured to selectively divert at least a portion of the generated hydrogen stream to the fluid ejectors 400A, 400B during steady-state operation.

During steady-state operation, the valves 64A, 64B, 66A, 66B, may be opened to provide sufficient fuel and anode exhaust flow through the manifolds 710, 720. In particular, both fluid ejectors 400A, 400B may be operated to provide a mixed steam comprising steam and hydrogen to the hotboxes 302 via the inlet manifold 720.

In some embodiments, hydrogen (H₂) and steam flow to at least one of the fluid ejectors 400A, 400B may be reduced or stopped by closing or partially closing the corresponding valves 64A, 64B, 66A, 66B. For example, hydrogen and steam flow may be reduced during transition operation and/or during low-load steady state operation.

FIG. 7D is a schematic diagram showing a process flow in an alternative SOEC system 700C, according to various embodiments of the present disclosure. The system 700C may include a combination of the components of the systems 700A and 700B. Accordingly, only the differences therebetween will be discussed in detail.

Referring to FIG. 7D, the system 700C may include at least two fluid ejectors 400A, 400B, a recycle blower 190, and the corresponding valves 64A, 64B, 66A, 66B, 68 to control steam and hydrogen flow therethrough. Accordingly, fluid flows through the fluid ejectors 400A, 400B, and the recycle blower 190 may be independently controlled by adjusting the valves 64A, 64B, 66A, 66B, 68, and/or controlling the operation of the recycle blower 190.

The optional pressure regulator 62 in the systems 700, 700A, 700B and/or 700C of FIGS. 7A, 7B, 7C and/or 7D may be replaced with a flow control valve (e.g., a valve similar to the valve 251 shown in FIG. 3 which controls the steam flow rate) if the system site control pressure of the steam is regulated. Alternatively, a flow control valve may be used in fluid series with the pressure regulator 62.

The fuel cell fuel cell systems of various embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. An electrochemical cell system, comprising:
a stack of electrochemical cells;
a first fluid ejector configured to mix a first fluid stream and a second fluid stream to form a mixed fluid stream that is provided to the stack, the first fluid ejector comprising:
a suction chamber comprising a secondary inlet configured to receive the second fluid stream;
an inlet nozzle configured to inject the first fluid stream into the suction chamber;
a mixing chamber fluidly connected to the suction chamber and configured to mix the first fluid stream and the second fluid stream to form the mixed fluid stream; and
a diffusion chamber fluidly connected to the mixing chamber and comprising an outlet that is fluidly connected to the stack.

2. The electrochemical system of claim 1, wherein:
the first fluid stream is configured to be provided to the inlet nozzle at a first velocity and a first pressure; and
the inlet nozzle is configured to inject the first fluid stream into the suction chamber at a second velocity that is higher than the first velocity and at a second pressure that is lower than the first pressure.

3. The electrochemical cell system of claim 2, wherein the suction chamber is configured to increase a velocity of the second fluid stream.

4. The electrochemical cell system of claim 2, wherein the diffusion chamber is configured to output the mixed fluid stream from the outlet at a third velocity that is less than the second velocity and at a third pressure that is higher than the second pressure.

5. The electrochemical cell system of claim 1, wherein the diffusion chamber comprises a diverging nozzle and the mixing chamber is narrower than the diffusion chamber and the suction chamber.

6. The electrochemical cell system of claim 1, further comprising:
a supply manifold or conduit configured to provide the first fluid stream to the inlet nozzle from a fluid source;
a recycling manifold or conduit fluidly connected to an outlet of the stack, and configured to provide the second fluid stream from the stack to the secondary inlet; and
an inlet manifold or conduit fluidly connecting the outlet to the stack.

7. The electrochemical cell system of claim 6, further comprising a second fluid ejector fluidly connected to the supply manifold or conduit, the recycling manifold or conduit, the inlet manifold or conduit, and the stack.

8. The electrochemical cell system of claim 6, further comprising a recycle blower fluidly connected to the recycling manifold or conduit and configured to provide the second fluid stream from the recycling manifold or conduit to the stack via the inlet manifold or conduit while bypassing the first fluid ejector.

9. The electrochemical cell system of claim 6, further comprising additional stacks of electrochemical cells located in a plurality of module housings.

10. The electrochemical cell system of claim 9, wherein:
the recycling manifold or conduit is configured to provide the second fluid stream from the plurality of module housings to the secondary inlet; and
the inlet manifold or conduit fluidly connects the outlet to the stacks located in the plurality of module housings.

11. The electrochemical cell system of claim 1, wherein:
the inlet nozzle is fluidly connected to a hydrogen fuel source;
the first fluid stream comprises a hydrogen fuel;
the second fluid stream comprises hydrogen and water; and
the electrochemical cells comprise fuel cells.

12. The electrochemical cell system of claim 11, further comprising a condenser configured to remove the water from the second fluid stream before the second fluid is provided to the first fluid ejector.

13. The electrochemical cell system of claim 1, wherein:
the inlet nozzle is fluidly connected to a steam source;
the first fluid stream comprises steam;
the second fluid stream comprises hydrogen and water; and
the electrochemical cells comprise electrolyzer cells.

14. A method of operating an electrochemical cell system, comprising:
providing a first fluid stream to an inlet nozzle of a fluid ejector;
providing a second fluid stream from a stack of electrochemical cells to a second inlet located in a suction chamber of the fluid ejector;
mixing the first fluid stream and the second fluid stream in a mixing chamber of the fluid ejector to form a mixed fluid stream; and
providing the mixed fluid stream from a diffusion chamber of the fluid ejector to the stack.

15. The method of claim 14, wherein:
the first fluid stream is provided to the inlet nozzle at a first velocity and a first pressure;
the inlet nozzle injects the first fluid stream into the suction chamber at a second velocity that is higher than the first velocity and at a second pressure that is lower than the first pressure;
the suction chamber increases a velocity of the second fluid stream; and
the diffusion chamber outputs the mixed fluid stream from the outlet at a third velocity that is less than the second velocity and at a third pressure that is higher than the second pressure.

16. The method of claim 15, wherein the diffusion chamber comprises a diverging nozzle and the mixing chamber is narrower than the diffusion chamber and the suction chamber.

17. The method of claim 14, wherein:
the first fluid stream comprises hydrogen fuel;
the second fluid stream comprises hydrogen and water; and
the electrochemical cells comprise fuel cells.

18. The method of claim 17, further comprising removing the water from the second fluid stream before the second fluid is provided to the fluid ejector.

19. The method of claim 14, wherein:
the first fluid stream comprises steam;
the second fluid stream comprises hydrogen and water, and
the electrochemical cells comprise electrolyzer cells.

20. The method of claim 14, further comprising using a recycle blower in a non-steady state mode to provide the second fluid stream to the stack while bypassing the fluid ejector.
